(19) United States
(12) Patent Application Publication
(10) Pub. No.: US 2015/0225977 A1
(43) Pub. Date: Aug. 13, 2015

(54) TENT STAKE REMOVAL TOOL

(71) Applicant: RONALD K. DAWSON, ANZA, CA (US)

(72) Inventor: RONALD K. DAWSON, ANZA, CA (US)

(21) Appl. No.: 14/445,548

(22) Filed: Jul. 29, 2014

Related U.S. Application Data
(60) Provisional application No. 61/937,085, filed on Feb. 7, 2014.

(51) Int. Cl. E04H 15/32; B66F 19/00

(52) U.S. Cl. CPC E04H 15/32; B66F 19/00

(57) ABSTRACT

A tent stake removal tool is configured to remove a tent stake having a bend from ground with an impulse. The tent stake removal tool includes a handle configured to accommodate at least two human hands and having a center of mass. A plurality of chain links includes a first chain link and a last chain link. The first chain link is mechanically coupled to the handle proximate the center of mass. A hook is attached to the last chain link and configured to fit around the bend. Rapidly lifting the handle from the tent stake causes the hook to apply the impulse to the bend pulling the tent stake from the ground.

### RELATED APPLICATION

This application claims priority to provisional patent application U.S. Ser. No. 61/937,085 filed on Feb. 7, 2014, the entire contents of which is herein incorporated by reference.

### BACKGROUND

The embodiments herein relate generally to camping equipment.

Prior to embodiments of the disclosed invention, tent stakes were removed with picks and shovels or left behind. Embodiments of the disclosed invention quickly and easily remove tent stakes from the ground.

### SUMMARY

A tent stake removal tool is configured to remove a tent stake from the ground with an impulse. The tent stake removal tool includes a handle configured to accommodate at least two human hands and having a center of mass. A plurality of chain links includes a first chain link and a last chain link. The first chain link is mechanically coupled to the handle proximate the center of mass. A hook is attached to the last chain link and configured to fit around the bend. Rapidly lifting the handle from the tent stake causes the hook to apply the impulse to the bend pulling the tent stake from the ground.

In some embodiments, the handle can comprise a ⅛ inch thick steel tubing that is 11 ½ inches long in order to accommodate at least two human hands. The plurality of chain links can comprise 17 connected ¼ inch thick chain links in order to prevent plastic deformation of the plurality of chain links while the tent stake removal tool is in use. The hook can be an S-hook that is ⅜ inch thick with a spring latch/clip in order to accommodate the bend.

A process for removing a tent stake in ground removes the tent stake by applying an impulse to a bend on the tent stake. The process can include the following steps: first, forming a tent stake removal tool by: first, obtaining a center of mass of a handle. Next, welding a first chain link to the center of mass of the handle. Then, attaching a plurality of chain links to the first chain link and including a last chain link. After that, attaching a hook to the last chain link. Following that, bending the hook that the hook will stay attached to the last chain link as though it was another chain link.

Next, placing the hook onto the bend on the tent stake. After that, tightening the plurality of chain links by pulling up on the handle until the plurality of chain links becomes taught. Then, pulling the handle laterally to loosen the tent stake. Following that, pulling the handle in a first direction and then pulling the handle in an opposite direction.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention, shown in use.

FIG. 2 is a side view of an embodiment of the invention.

FIG. 3 is a section view, taken along line 3-3 in FIG. 1.

FIG. 4 is a section view, taken along line 4-4 in FIG. 3.

FIG. 5 is a front view of an embodiment of the invention.

### DETAILED DESCRIPTION OF CERTAIN EMBODIMENTS

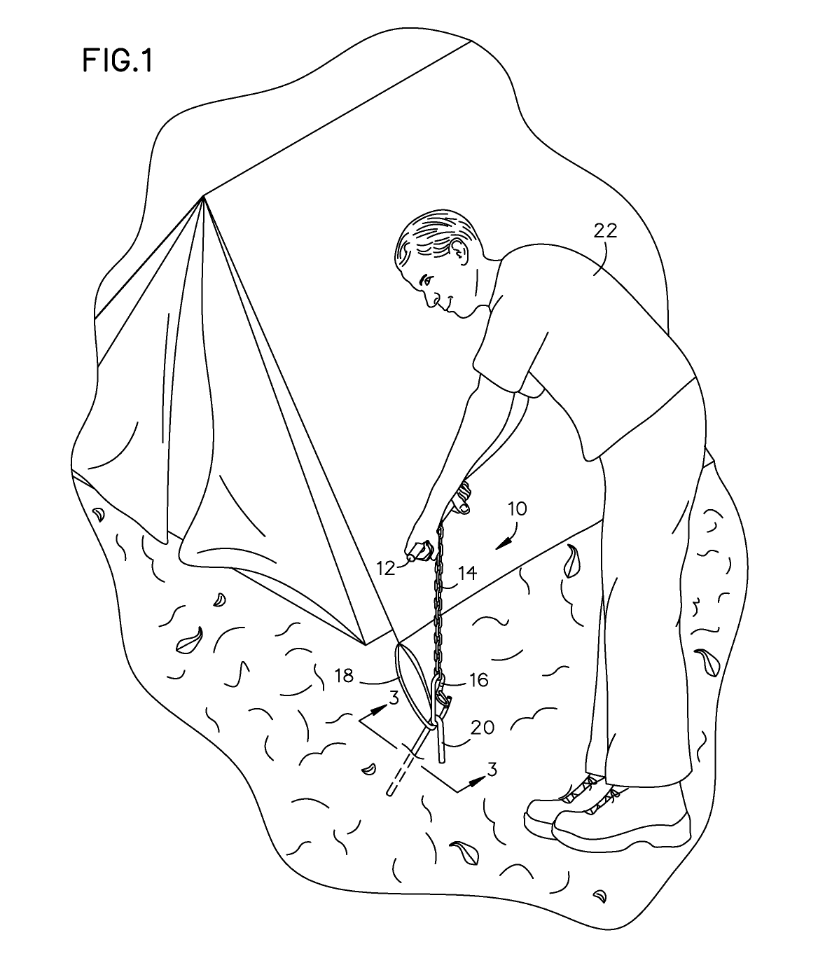

By way of example, and referring to FIG. 1, user 22 desires to remove tent stake 20 from ground in order to detach tent 18 from ground. Tent stake removal tool 10 is effective in this regard.

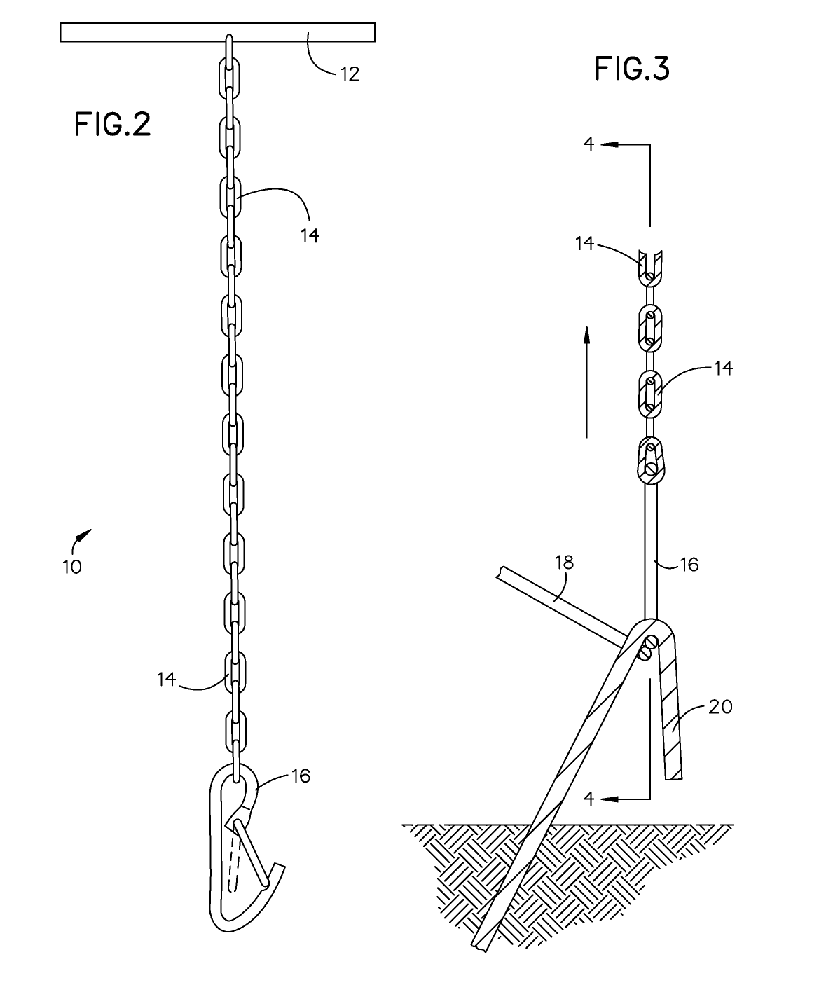

Turning to FIG. 2 and FIG. 3, tent stake removal tool 10 comprises handle 12 mechanically coupled to a plurality of chain links 14. The plurality of chain links 14 are mechanically coupled to hook 16. Hook 16 is configured to fit around a bend in tent stake 20.

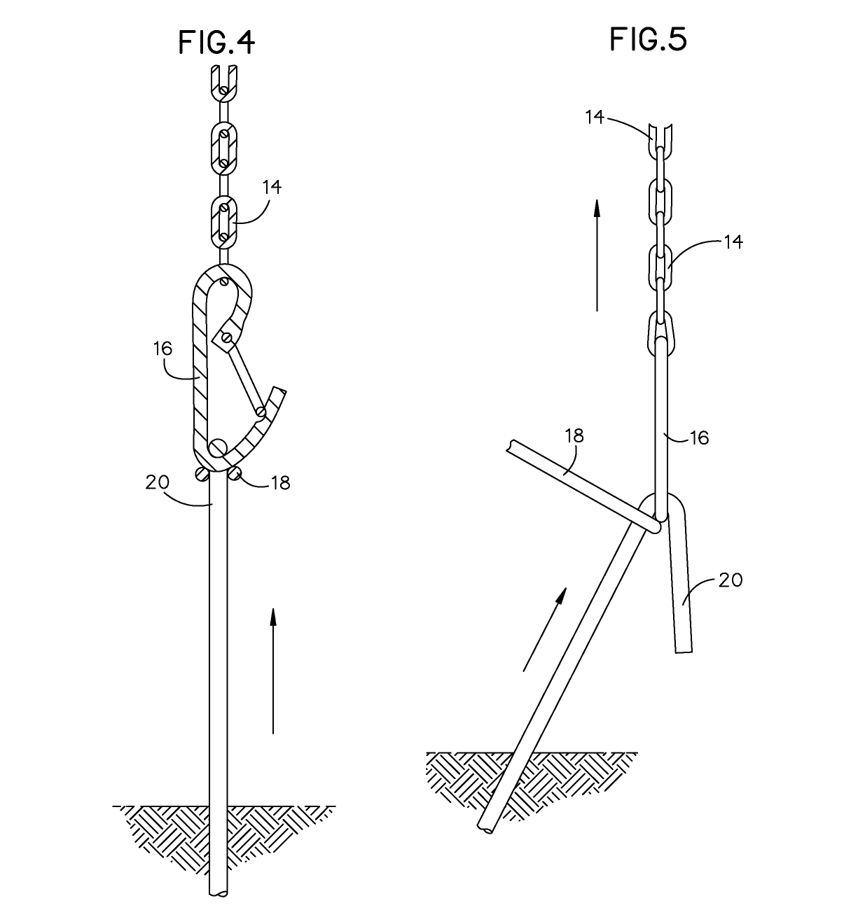

As shown in FIG. 4 and FIG. 5, tent stake removal tool 10 is an impact tool in that it is configured to render a substantial force over a very short period of time onto the bend in tent stake 20. Impulse (J) is the product of a force (F) and the time (t) for which it acts. The impulse of a force acting for a given time interval is equal to the change in linear momentum (p) produced over that interval. Impulse is a vector quantity since it is the result of integrating force, a vector quantity, over time. Mass (m) and velocity (v) are offered below as another representation of this.

l=∫^{t2}ₜ₁Fdt=Δp=m(v2−v1)

In order to move tent stake 20, the force must act suddenly and quickly. To contrast the present invention with, say, a claw hammer, the claw hammer will react with tent stake 20 over a longer period of time and in a less direct manner, requiring substantially more effort in order to be effective. Tent stake removal tool 10 exerts force over the single moment when the plurality of chain links 14 reach their maximum length as shown in FIG. 1, that is, where each chain length is in contact with a distal point of another chain link.

Turning to the components in more detail, handle 12 should be sufficiently long as to allow at least two human hands to be placed upon it some distance apart. In some embodiments, handle 12 comprises ⅛ inch thick steel tubing that is 11 ½ inches long. The plurality of chain links 14 should be sufficiently small so as not to be too heavy in order to lift—as newton's third law would indicate that a heavier chain would cause a force that must be overcome in order to create the impulse in the first instance. However, the plurality of chain links 14 should be sufficiently strong so as not to have plastic deformation while being used. In some embodiments the plurality of chain links 14 are 22 inches of ¼ inch thick chain which is about 17 links. Hook 16 should not plastically deform as well, but must be sufficiently large to accommodate the bend in tent stake 20. In some embodiments hook 16 is an S-hook that is ⅜ inch thick with a spring latch/clip.

Tent stake removal tool 10 can be assembled by obtaining the center of mass of handle 12 and welding a first chain link 14 to the center of mass of the handle. Then, attaching hook 16 to the last chain link 14 at the opposite end of the plurality of chain links 14. After that, bending hook 16 so that it will stay attached to chain 14 as though it was another link of chain 14.

A process for removing tent stake 22 can include using tent stake removal tool 10 by placing hook 16 onto a ring or bend on tent stake 20 which is in the ground. The user can then pick up handle 12 and hold it with at least two hands, one hand on each side of the plurality of chain links 14 and pull up until the plurality of chain links 14 becomes taught. After this, a user can pull handle 12 in an upward manner to loosen tent stake 20. If this procedure is ineffective, the user could rapidly pull handle 12 toward the user a few times in a first direction and then additionally in an opposite direction.

Notably, using a plurality of chain links 14 provides several distinct advantages over the prior art. First, it can more easily be wrapped around solid objects to obtain additional mechanical leverage. Second, in addition to movement, rapidly pulling on the handle, causing the chain to become loose and tight will create vibration in addition to force that can loosen tent stake 20.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A tent stake removal tool, configured to remove a tent stake having a bend from ground with an impulse; the tent stake removal tool comprising:
a handle configured to accommodate at least two human hands and having a center of mass;
a plurality of chain links including a first chain link and a last chain link; wherein the first chain link is mechanically coupled to the handle proximate the center of mass;
a hook, attached to the last chain link and configured to fit around the bend;
wherein rapidly lifting the handle from the tent stake causes the hook to apply the impulse to the bend pulling the tent stake from the ground.

2. The tent stake removal tool of claim 1, wherein the handle comprises a ⅛ inch thick steel tubing that is 11 ½ inches long in order to accommodate the two human hands.

3. The tent stake removal tool of claim 2, wherein the plurality of chain links further comprises 17 connected ¼ inch thick chain links in order to prevent plastic deformation of the plurality of chain links while the tent stake removal tool is in use.

4. The tent stake removal tool of claim 3, wherein the hook is an S-hook that is ⅜ inch thick with a spring latch/clip in order to accommodate the bend.

5. A process for removing a tent stake in ground removes the tent stake by applying an impulse to a bend on the tent stake; the process comprising:
forming a tent stake removal tool by:
obtaining a center of mass of a handle;
welding a first chain link to the center of mass of the handle;
attaching a plurality of chain links to the first chain link and including a last chain link;
attaching a hook to the last chain link
bending the hook that the hook will stay attached to the last chain link as though it was another chain link;
placing the hook onto the bend on the tent stake;
tightening the plurality of chain links by pulling up on the handle until the plurality of chain links becomes taught;
pulling the handle upward to loosen the tent stake.

6. The process of claim 5 further comprising: pulling the handle in a first direction and then pulling the handle in an opposite direction.
